(19) United States
(12) Patent Application Publication
(10) Pub. No.: US 2018/0225475 A1
(43) Pub. Date: Aug. 9, 2018

(54) ENCRYPTED DATABASE MANAGEMENT DEVICE, ENCRYPTED DATABASE MANAGEMENT METHOD, ENCRYPTED DATABASE MANAGEMENT PROGRAM, AND ENCRYPTED DATABASE MANAGEMENT SYSTEM

(71) Applicant: NEC Corporation, Tokyo (JP)

(72) Inventor: Takayuki WATANABE, Tokyo (JP)

(73) Assignee: NEC Corporation, Tokyo (JP)

(21) Appl. No.: 15/888,325

(22) Filed: Feb. 5, 2018

(30) Foreign Application Priority Data
Feb. 9, 2017 (JP) 2017-022247

(51) Int. Cl. G06F 21/62; G06F 12/14; G06N 99/00

(52) U.S. Cl. CPC G06F 21/6227; G06F 12/1408; G06F 2212/1052; G06F 2221/2141; G06N 99/005

(57) ABSTRACT

An encrypted database management system includes an encrypted database management device and a storage device including an encrypted database storing encrypted data, in which the encrypted database management device includes: a determination unit which determines an encryption scheme used for encrypting a query, on the basis of the query and a predetermined model; and an encryption unit which uses the encryption scheme determined to encrypt the query.

This application is based upon and claims the benefit of priority from Japanese patent application No. 2017-022247, filed on Feb. 9, 2017, the disclosure of which is incorporated here in its entirety by reference.

### BACKGROUND

### Technical Field

The present invention relates to an encrypted database management device, an encrypted database management method, an encrypted database management program, and an encrypted database management system.

### Background Art

Due to the spread of the Internet of Things (IoT) technology, analysis results of large amounts of data are expected to be effectively utilized in business and society. At the same time, risk is also increasing of mass leakage of personal information and confidential information due to negligence or malice.

As a technology to prevent information leakage due to internal crime from organizations managing confidential information, a “encrypted database system” is known in which data is stored in an encrypted state and query processing for search, magnitude comparison, computation, or the like is performed on encrypted data. The encrypted database system is also useful from a viewpoint of efficient analysis and utilization of large amounts of data.

For example, PTL 1 describes a secret data processing system that changes processing of an application such that processing on encrypted data itself can be processed in an environment where security is secured, regardless of processing restriction due to an encryption scheme.

A general encrypted database system includes one or more “clients” and one or more “centers”. FIG. 12 is a block diagram showing a configuration example of the general encrypted database system.

As showed in FIG. 12, a encrypted database system 11 includes clients 100 to 10n (n is an integer of 1 or more) and a center 200. The encrypted database system 11 showed in FIG. 12 includes only one center. That is, the encrypted database system 11 includes a total of n clients and one center 200.

The center 200 is communicably connected to each of the clients 100 to 10n. The center 200 and the clients 100 to 10n each have a data transmission/reception function.

A client is a standalone device such as a smartphone. The client may be a combination of a computer and an I/O terminal such as a mouse or a monitor, or a combination of a set top box and various sensors such as a temperature/humidity sensor and an illuminance sensor, or a camera. The client may be an electric appliance, an automobile, or a robot that communicably connects to a communication network and transmits acquired data.

An external system 20 showed in FIG. 12 issues a predetermined query from the outside to the encrypted database system 11 to perform “processing of registration and the like”, such as registration of data, update of data, or deletion of data.

The external system 20 performs “processing of data utilization” such as an arithmetic operation, magnitude comparison, or search, for data registered by issuing the predetermined query from the outside. After the “processing of data utilization” is executed, the external system 20 can receive a utilization result of the data.

As showed in FIG. 12, the client 100 includes an external interface unit 110, a query execution unit 120, and an encryption/decryption processing unit 130. Each configuration of the clients 101 to 10n is similar to the configuration of the client 100.

The external interface unit 110 has a function as an interface connected to the outside. The external interface unit 110 communicates with the query execution unit 120 and the encryption/decryption processing unit 130. Data input to the external interface unit 110 showed in FIG. 12 represents information itself registered in a encrypted database 220.

The query execution unit 120 has a function of executing the query issued from the external system 20. The query execution unit 120 executes the query to perform the processing of registration and the like, and the processing of data utilization on the encrypted database 220. The query execution unit 120 communicates with the encryption/decryption processing unit 130.

The encryption/decryption processing unit 130 has a function of interpreting contents of the query received. The encryption/decryption processing unit 130 includes an encryption scheme table. The encryption/decryption processing unit 130 has a function of performing encryption and decryption of target data and the like of the query processing, on the basis of information set in the encryption scheme table.

Specifically, the encryption/decryption processing unit 130 uses the encryption scheme table in which an encryption scheme is set for each specific data area in the table, to perform encryption and decryption with the encryption scheme set. Users are required to preset the encryption scheme in the encryption scheme table. The encryption/decryption processing unit 130 communicates with the center 200.

The encryption scheme table includes information indicating the encryption scheme corresponding to the specific data area in a table stored in a database that is an execution target of the query. The specific data area is, for example, a column of the table.

The encryption scheme set in the encryption scheme table is, for example, a “searchable probabilistic encryption scheme” suitable for a search that secures security with a few data patterns such as a gender, a “sequence comparison encryption scheme” suitable for magnitude comparison, and a “homomorphic encryption scheme” suitable for an arithmetic operation.

FIG. 13 is an explanatory diagram showing an example of the encryption scheme table. In the encryption scheme table showed in FIG. 13, a set value of a current encryption scheme is held for each column of the table.

For example, as showed in FIG. 13, in the encryption scheme table, information is held that a first encryption scheme is currently set for a first column of a first table. The first encryption scheme is, for example, the searchable probabilistic encryption scheme.

Similarly, in the encryption scheme table, as showed in FIG. 13, information is held that a second encryption scheme is currently set for a second column of the first table, and a third encryption scheme is currently set for a first column of a second table.

The second encryption scheme is, for example, the sequence comparison encryption scheme. The third encryption scheme is, for example, the homomorphic encryption scheme. In the encryption scheme table, the set value of the current encryption scheme is held for each column of each table as described above.

The encryption/decryption processing unit 130 transmits an error result including information indicating whether or not the query processing can be executed in a case where the query is encrypted by the encryption scheme set in the encryption scheme table, as “query statement and error result”, to a query execution unit 210 of the center 200.

As showed in FIG. 12, the center 200 includes the query execution unit 210 and the encrypted database 220.

The query execution unit 210 has a function of executing a query issued from the external system 20. The query execution unit 210 executes the query to perform the processing of registration and the like and the processing of data utilization on the encrypted database 220.

The query execution unit 210 communicates with each of encryption/decryption processing units of respective n clients. The query execution unit 210 communicates with the encrypted database 220. In the encrypted database 220, data and the like are stored in the encrypted state.

The data input to the client 100 is encrypted by the encryption/decryption processing unit 130 with the encryption scheme set in the encryption scheme table. The encrypted data is transmitted to the center 200. The center 200 stores the encrypted data in the encrypted state transmitted from each client in the encrypted database 220.

Hereinafter, operation will be described of registering data of the encrypted database system 11 showed in FIG. 12 with reference to FIG. 14. FIG. 14 is a flowchart showing operation of data registration processing by the general encrypted database system.

A query for registering data is issued from the external system 20 to the external interface unit 110 (step S001). The external interface unit 110 inputs the issued query to the encryption/decryption processing unit 130 (step S002).

Next, the encryption/decryption processing unit 130 confirms that “INSERT” statement is described in the received query. That is, the encryption/decryption processing unit 130 identifies that the query processing is data registration processing (step S003).

Next, the encryption/decryption processing unit 130 refers to the encryption scheme table to confirm the encryption scheme set for a column of a table to be subjected to the query processing. The encryption/decryption processing unit 130 encrypts the input query with the confirmed encryption scheme (step S004).

Next, the encryption/decryption processing unit 130 transmits the encrypted query to the center 200. The query execution unit 210 of the center 200 receives the transmitted encrypted query (step S005).

Next, the query execution unit 210 executes the query processing on the encrypted database 220 in accordance with contents of the received encrypted query (step S006). In this example, the query execution unit 210 inserts the data into a table stored in the encrypted database 220. After executing the query processing, the encrypted database system 11 ends the data registration processing.

As described above, after step S004, the data to be registered remains in the encrypted state. That is, in the center 200, the data to be registered is always in the encrypted state. The “processing of registration and the like” other than the data registration processing is also executed in operation similar to the operation showed in FIG. 14.

Next, operation will be described of performing the “processing of data utilization” on the registered data of the encrypted database system 11 showed in FIG. 12, with reference to FIG. 15. FIG. 15 is a flowchart showing operation of data utilization processing by the general encrypted database system.

A query for performing the “processing of data utilization” is issued from the external system 20 to the external interface unit 110 (step S011). The external interface unit 110 inputs the issued query to the encryption/decryption processing unit 130 (step S012).

Next, the encryption/decryption processing unit 130 identifies details of the query processing on the basis of the received query (step S013).

Next, the encryption/decryption processing unit 130 refers to the encryption scheme table to confirm the encryption scheme set for a column of a table to be subjected to the query processing. The encryption/decryption processing unit 130 generates an error result including information indicating whether or not the query encrypted with the confirmed encryption scheme can be executed (step S014).

Next, the encryption/decryption processing unit 130 refers to the encryption scheme table to encrypt the query with the encryption scheme set for the column of the table to be subjected to the query processing (step S015).

After encrypting the query, the encryption/decryption processing unit 130 transmits, to the center 200, the encrypted query and the generated error result as the query statement and error result. The query execution unit 210 of the center 200 receives the transmitted query statement and error result (step S016).

Next, the query execution unit 210 refers to the received query statement and error result to confirm whether or not the encrypted query can be executed by the center 200 (step S017).

In a case where the encrypted query can be executed by the center 200 (Yes in step S017), the query execution unit 210 executes the encrypted query on the encrypted database 220 (step S018). A processing result of the encrypted query is also encrypted with the same encryption scheme as that for the encrypted query.

After executing the encrypted query, the query execution unit 210 transmits the processing result to the encryption/decryption processing unit 130 of a client that has transmitted the query statement and error result. The encryption/decryption processing unit 130 receives the transmitted processing result (step S019).

Next, the encryption/decryption processing unit 130 refers to the encryption scheme table to confirm an encryption scheme set for a column of a target table corresponding to the received processing result. The encryption/decryption processing unit 130 decrypts the received processing result with the confirmed encryption scheme (step S020).

Next, the encryption/decryption processing unit 130 inputs the decrypted processing result to the external interface unit 110. The external interface unit 110 returns the decrypted processing result to the external system 20 (step S021). After returning the processing result, the encrypted database system 11 ends the data utilization processing.

In a case where the encrypted query cannot be executed by the center 200 (No in step S017), the query execution unit 210 acquires all data to be processed of the encrypted query stored in the encrypted database 220 (step S022).

For example, in a case where the query includes a match search over a predetermined column, the query execution unit 210 acquires all data of the predetermined column. In a case where the query includes an arithmetic operation for obtaining a sum of values of other columns corresponding to columns that can be subjected to the match search processing by the center 200, the query execution unit 210 acquires all the corresponding data (values) of the other columns.

Next, the query execution unit 210 transmits the data to be processed acquired in step S022 in the encrypted state to the encryption/decryption processing unit 130 of the client that has transmitted the query statement and error result. The encryption/decryption processing unit 130 receives the transmitted data to be processed (step S023).

Next, the encryption/decryption processing unit 130 refers to the encryption scheme table to confirm the encryption scheme set for a column of a target table in which the received data to be processed is stored. The encryption/decryption processing unit 130 decrypts the received data to be processed with the confirmed encryption scheme (step S024).

Next, the encryption/decryption processing unit 130 inputs the decrypted data to be processed to the query execution unit 120. The query execution unit 120 executes the query issued from the external system 20 on the input data to be processed (step S025).

After executing the query, the query execution unit 120 returns a processing result of the query to the external system 20 (step S026). After returning the processing result, the encrypted database system 11 ends the data utilization processing.

In a case where processing that cannot be executed by the center 200 is part of the query processing, only the processing that cannot be executed may be executed by the query execution unit 120 of the client 100. Next, the encryption/decryption processing unit 130 may encrypt the processing result to transmit the result to the center 200, and the query execution unit 210 of the center 200 may continuously execute the rest of the query processing that can be executed.

### CITATION LIST

### Patent Literature

PTL 1: Japanese Patent Application Laid-Open No. 2016-177400

PTL 2: Japanese Patent Application Laid-Open No. 2014-211607

### SUMMARY

An exemplary object of the present invention is to provide an encrypted database management device, an encrypted database management method, an encrypted database management program, and an encrypted database management system capable of encrypting a query issued to an encrypted database with an appropriate encryption scheme.

An encrypted database management device according to the present invention includes: a determination unit which determines an encryption scheme used for encrypting a query, on the basis of the query and a predetermined model; and an encryption unit which uses the encryption scheme determined to encrypt the query.

An encrypted database management method according to the present invention includes: determining an encryption scheme used for encrypting a query, on the basis of the query and a predetermined model; and using the encryption scheme determined to encrypt the query.

A non-transitory computer-readable recording medium having recorded therein an encrypted database management program according to the present invention that, when executed by a computer, determines an encryption scheme used for encrypting a query, on the basis of the query and a predetermined model, and uses the encryption scheme determined to encrypt the query.

An encrypted database management system according to the present invention includes an encrypted database management device and a storage device including an encrypted database storing encrypted data, in which the encrypted database management device includes: a determination unit which determines an encryption scheme used for encrypting a query, on the basis of the query and a predetermined model; and an encryption unit which uses the encryption scheme determined to encrypt the query.

### BRIEF DESCRIPTION OF THE DRAWINGS

FIG. 1 is a block diagram showing a configuration example of a first exemplary embodiment of a encrypted database system 10 according to the present invention.

FIG. 2 is an explanatory diagram showing an example of statistical data included in an encryption scheme determination unit 140.

FIG. 3 is an explanatory diagram showing an example of a learning model estimated by the encryption scheme determination unit 140.

FIG. 4 is an explanatory diagram showing an example of a predetermined algorithm included in the encryption scheme determination unit 140.

FIG. 5 is an explanatory diagram showing an example of a relevance table in which relevance between a condition and an encryption scheme is held.

FIG. 6 is a flowchart showing operation of data utilization processing by the encrypted database system 10 of the first exemplary embodiment.

FIG. 7 is a flowchart showing operation of data synchronization processing by the encrypted database system 10 of the first exemplary embodiment.

FIG. 8 is a block diagram showing a configuration example of a second exemplary embodiment of the encrypted database system 10 according to the present invention.

FIG. 9 is a flowchart showing operation of data utilization processing by the encrypted database system 10 of the second exemplary embodiment.

FIG. 10 is a block diagram showing an outline of an encrypted database management device according to the present invention.

FIG. 11 is a block diagram showing an outline of an encrypted database management system according to the present invention.

FIG. 12 is a block diagram showing a configuration example of a general encrypted database system.

FIG. 13 is an explanatory diagram showing an example of an encryption scheme table.

FIG. 14 is a flowchart showing operation of data registration processing by the general encrypted database system.

FIG. 15 is a flowchart showing operation of data utilization processing by the general encrypted database system.

### DESCRIPTION OF EXEMPLARY EMBODIMENT

Hereinafter, exemplary embodiments of the present invention will be described with reference to the drawings.

An encrypted database management device according to the present invention uses a learning model generated by machine learning on the basis of a “data class”, or a predetermined algorithm, to determine and set an appropriate encryption scheme for each column of a table stored in a encrypted database, for example.

In each exemplary embodiment, the “data class” means any of “data” and “metadata”, or “statistical data”. The definition of each term is as follows.
Data: information itself registered in the encrypted database
Metadata: information attached to “data” (for example, a table name and a column name)
Statistical data: information in which contents of a query issued to the encrypted database and an “error result” are accumulated

The contents of the query issued to the encrypted database is, for example, a SELECT clause including arithmetic operators (‘+’, ‘−’, ‘*’, ‘/’) and the like. The “data class” of a first exemplary embodiment is the “statistical data”. The “data class” in a second exemplary embodiment includes the “data” and the “metadata”.

### FIRST EXEMPLARY EMBODIMENT

### Description of Configuration

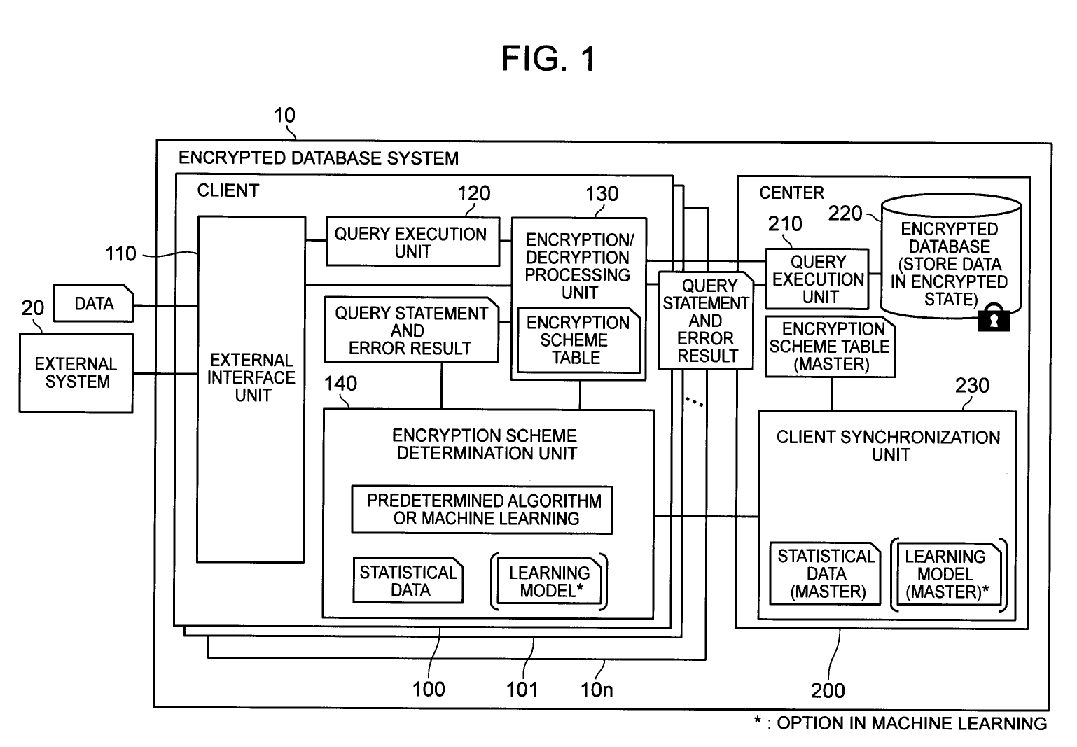

FIG. 1 is a block diagram showing a configuration example of a first exemplary embodiment of a encrypted database system 10 according to the present invention. As described above, the “data class” of the present exemplary embodiment is the “statistical data”.

The encrypted database system 10 of the present exemplary embodiment is a system that uses a learning model generated by machine learning or a predetermined algorithm on the basis of the statistical data, to determine and set an appropriate encryption scheme.

A center of the present exemplary embodiment includes a client synchronization unit that is a component used for sharing a setting of the appropriate encryption scheme among multiple clients. In a case where the center includes the client synchronization unit, the appropriate encryption scheme is selected and set over the entire encrypted database system, so that the total execution time of query processing is shortened.

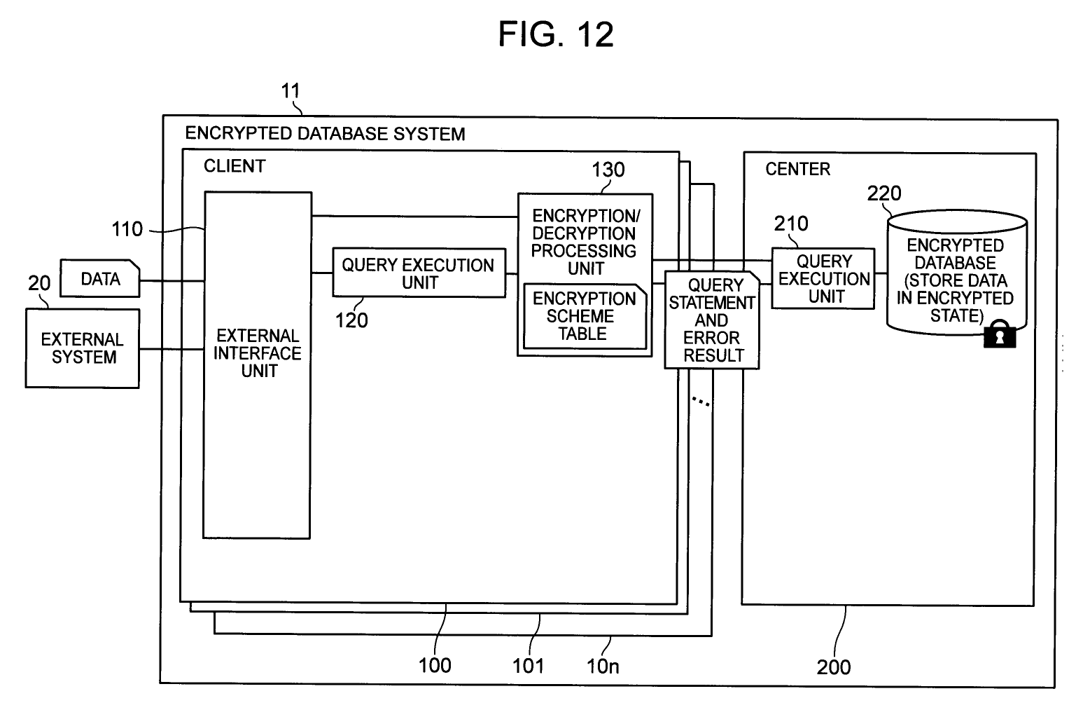

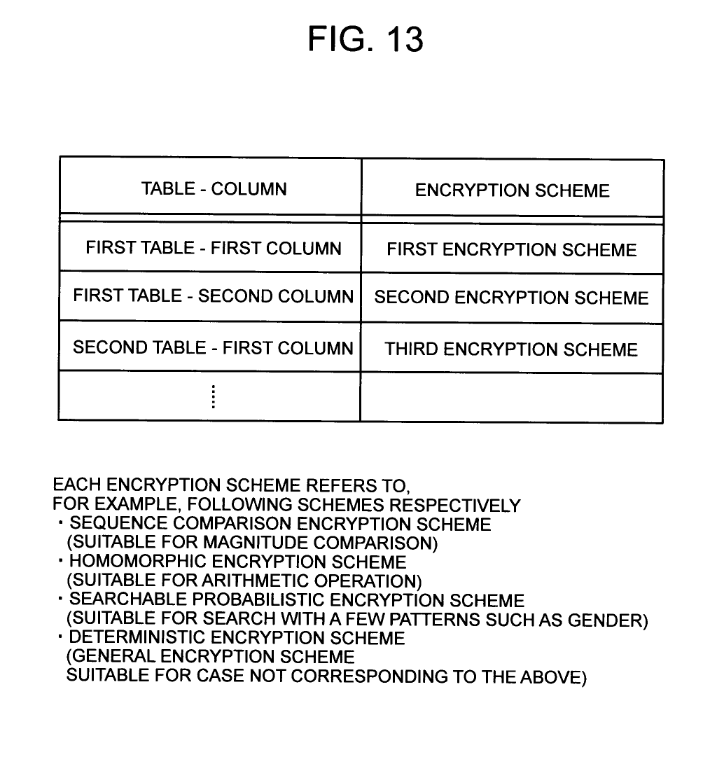

The encrypted database system 10 showed in FIG. 1 includes clients 100 to 10n and a center 200, similarly to the encrypted database system 11 showed in FIG. 12.

The center 200 is communicably connected to each of the clients 100 to 10n. The center 200 and the clients 100 to 10n each have a data transmission/reception function.

As showed in FIG. 1, the client 100 of the present exemplary embodiment includes an external interface unit 110, a query execution unit 120, an encryption/decryption processing unit 130, and an encryption scheme determination unit 140. Each configuration of the clients 101 to 10n is similar to the configuration of the client 100.

As showed in FIG. 1, the center 200 of the present exemplary embodiment includes a query execution unit 210, a encrypted database 220, and a client synchronization unit 230.

Each component of the external interface unit 110, the query execution unit 120, the encryption/decryption processing unit 130, the query execution unit 210, and the encrypted database 220, showed in FIG. 1 has a function similar to the corresponding component showed in FIG. 12. That is, the configuration of the first exemplary embodiment other than the encryption scheme determination unit 140 and the client synchronization unit 230 is similar to the configuration showed in FIG. 12.

The client of the present exemplary embodiment includes the encryption scheme determination unit 140. The encryption scheme determination unit 140 includes a model generated on the basis of the predetermined algorithm (hereinafter simply referred to as the predetermined algorithm) or a function of machine learning (hereinafter simply referred to as the machine learning). When including the machine learning, the encryption scheme determination unit 140 further includes the learning model.

The predetermined algorithm is a fixed algorithm set in advance by a provider of the encrypted database system 10 on the basis of theories and experiences. The machine learning is a function in which the encrypted database system 10 performs learning to find a regularity, and uses the found regularity to helpfully perform prediction.

The encryption/decryption processing unit 130 communicates with the encryption scheme determination unit 140. The encryption/decryption processing unit 130 inputs an error result and a query statement itself, as “query statement and error result” to the encryption scheme determination unit 140, in which the error result includes information indicating whether or not an error occurs when a query encrypted with an encryption scheme set in an encryption scheme table is executed.

The encryption scheme determination unit 140 includes the predetermined algorithm or the machine learning, and the statistical data. As described above, the encryption scheme determination unit 140 includes any of the predetermined algorithm and the machine learning.

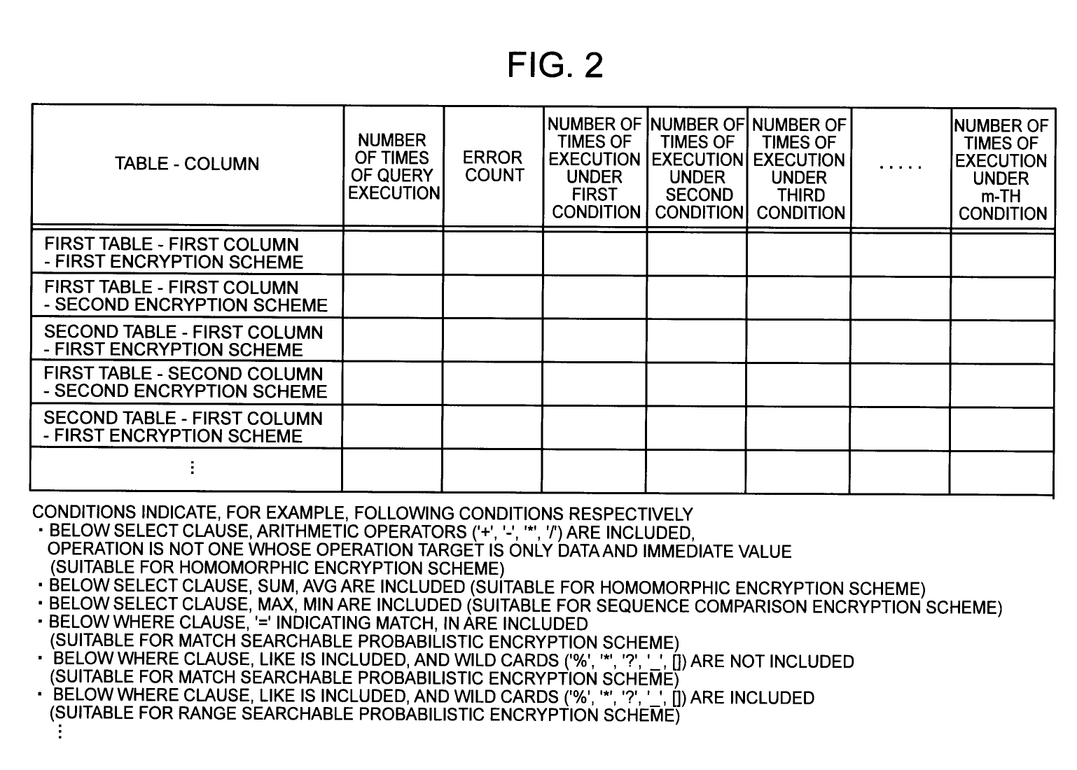

The statistical data is data in which the query statement and error result input from the encryption/decryption processing unit 130 is accumulated. FIG. 2 is an explanatory diagram showing an example of statistical data included in the encryption scheme determination unit 140. As showed in FIG. 2, the statistical data includes “table-column”, “number of times of query execution”, “error count”, and the number of times of execution under each condition.

The “table-column” indicates a table and a column to be subjected to the query processing and the encryption scheme used for encryption. The “number of times of query execution” indicates the number of times of execution of the query processing. The “error count” indicates the number of times of execution of the query processing in which an error has occurred.

The number of times of execution under each condition indicates the number of times of execution of the query processing executed under each specified condition. The specified conditions are showed in the lower part of FIG. 2.

In the statistical data showed in FIG. 2, each condition is summarized for each condition including a type of character string considered to depend on one encryption scheme. However, in the statistical data, each condition need not be summarized.

For example, a condition A including ‘+’ and a condition B including ‘−’ may be combined into one as a condition C including ‘+−’ in the statistical data, or may not be combined together. A query including at least one of ‘+’ or ‘−’ applies to the condition C. Multiple conditions may be combined in other ways.

Hereinafter, a case will be described where the encryption scheme determination unit 140 includes the machine learning. When including the machine learning, the encryption scheme determination unit 140 includes the learning model. The learning model of the present exemplary embodiment is a model indicating a boundary of application of each encryption scheme estimated by the encryption scheme determination unit 140 on the basis of the statistical data.

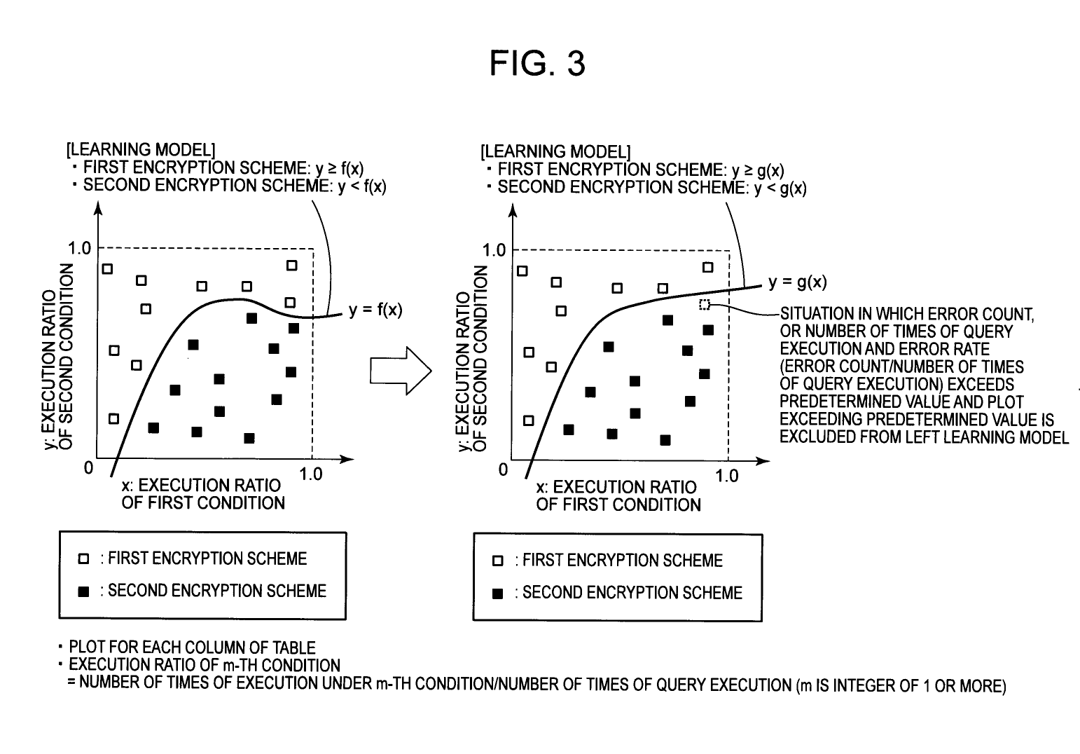

FIG. 3 is an explanatory diagram showing an example of a learning model estimated by the encryption scheme determination unit 140. In each graph showed in FIG. 3, the x axis indicates an execution ratio of a first condition, and the y axis indicates an execution ratio of a second condition.

The execution ratio of the first condition is computed by (the number of times of query execution under the first condition/the number of times of query execution). The execution ratio of the second condition is computed by (the number of times of query execution under the second condition/the number of times of query execution). The first condition and the second condition correspond to the conditions showed in FIG. 2.

That is, each graph showed in FIG. 3 is a graph in which the statistical data is plotted such that it is distinguished which one of a first encryption scheme and a second encryption scheme is appropriate as an encryption scheme for a query. The encryption scheme determination unit 140 derives a function y=f(x) indicating the boundary between the first encryption scheme and the second encryption scheme in the graph. The learning model of the present exemplary embodiment refers to a formula derived as described above, or a set of formulas, which estimates which of the first encryption scheme or the second encryption scheme is appropriate to a combination of x and y.

In a graph showed on the right in FIG. 3, one plot represented by a broken-line rectangle is removed from a graph showed on the left. As the plot is removed, the function indicating the boundary between the first encryption scheme and the second encryption scheme is updated to y=g(x). That is, the encryption scheme determination unit 140 updates the learning model from y=f(x) to y=g(x). After the learning model is updated, for example, the second encryption scheme is newly selected for a column of a target table.

Although the two-dimensional graph corresponding only to the first condition and the second condition is showed in FIG. 3 for simplicity, an m-dimensional graph may be used corresponding from the first condition to an m-th condition (m is an integer of 1 or more). That is, the function indicating the boundary of the encryption scheme may be a function corresponding to m conditions instead of the function y=f(x) corresponding to the two conditions showed in FIG. 3.

In FIG. 3 corresponding to a case of the two encryption schemes, only the function y=f(x) showing the boundary of the two encryption schemes is showed. Although only the boundary between the two encryption schemes of the first encryption scheme and the second encryption scheme is indicated in each graph in FIG. 3 for simplicity, each boundary between three or more encryption schemes may be indicated.

For example, m functions y=fᵢ(x) to y=fₘ(x) may be indicated on the graph showed in FIG. 3, and the conditions under which respective encryption schemes are applied may be set, such as “the first encryption scheme: y<fᵢ(x), the second encryption scheme: fᵢ(x)≤y<f₂ (x), . . . , the m-th encryption scheme: fₘ₋₁(x)≤y<fₘ(x)”. The conditions may be set in a format other than the above format.

As described above, an example of the machine learning performed by the encryption scheme determination unit 140 has been described; however, the machine learning performed by the encryption scheme determination unit 140 may be machine learning with another scheme.

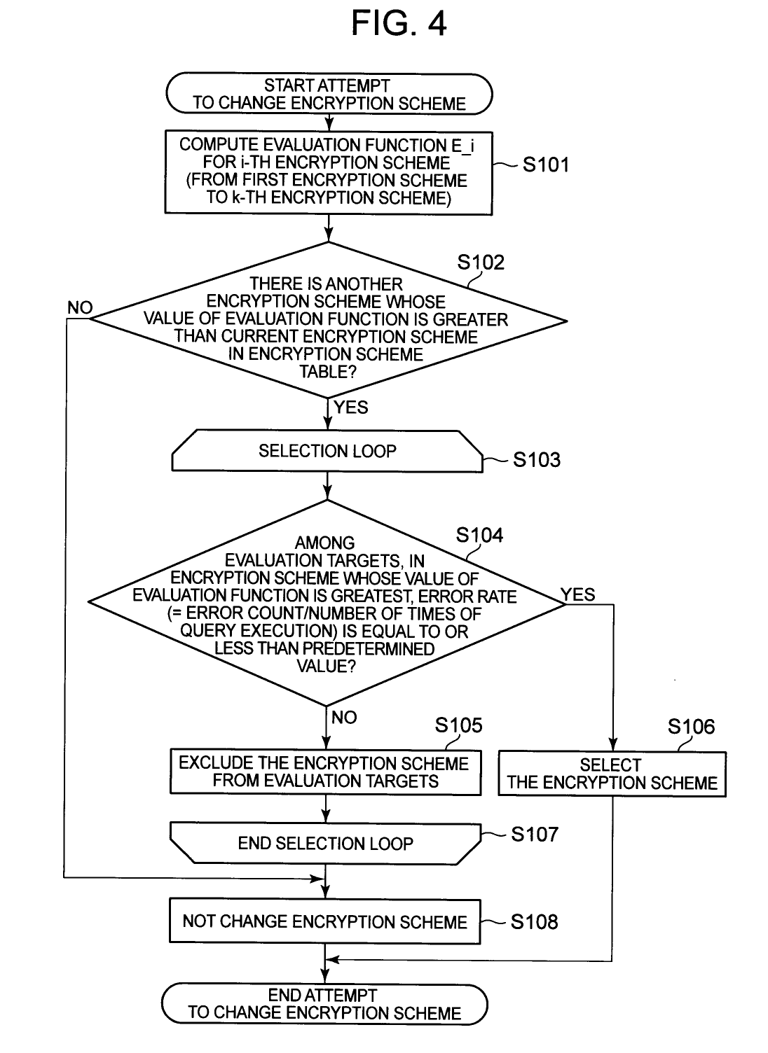

Hereinafter, a case will be described where the encryption scheme determination unit 140 includes the predetermined algorithm. FIG. 4 is an explanatory diagram showing an example of the predetermined algorithm included in the encryption scheme determination unit 140.

The encryption scheme determination unit 140 starts an attempt to change the encryption scheme in accordance with the algorithm showed in FIG. 4, for example. The encryption scheme determination unit 140 computes evaluation function E_i for each i-th encryption scheme (i=1 to k), respectively (step S101).

Next, the encryption scheme determination unit 140 determines whether or not there is at least one encryption scheme whose value of the evaluation function computed is greater than a value of the evaluation function for the encryption scheme currently set, in the encryption scheme table (step S102).

In a case where there is no encryption scheme whose value of the evaluation function is greater than the value of the evaluation function for the encryption scheme currently set (No in step S102), the encryption scheme determination unit 140 does not change the encryption scheme (step S108). The encryption scheme determination unit 140 ends the attempt to change the encryption scheme without changing the encryption scheme.

In a case where there is at least one encryption scheme whose value of the evaluation function is greater than the value of the evaluation function for the encryption scheme currently set (Yes in step S102), the encryption scheme determination unit 140 extracts the encryption scheme whose value of the evaluation function is greater as an evaluation target. That is, the encryption scheme determination unit 140 enters a selection loop (step S103).

The encryption scheme determination unit 140 confirms whether or not an error rate of the encryption scheme whose value of the evaluation function is the greatest among the evaluation targets is equal to or less than a predetermined value (step S104). The error rate is computed by (the error count/the number of times of query execution), for example.

In a case where the error rate is greater than the predetermined value (No in step S104), the encryption scheme determination unit 140 excludes the encryption scheme whose error rate is greater than the predetermined value from the evaluation targets (step S105). After excluding the encryption scheme, the encryption scheme determination unit 140 again performs the processing of step S104.

In a case where the error rate is equal to or less than the predetermined value (Yes in step S104), the encryption scheme determination unit 140 selects the encryption scheme whose error rate is equal to or less than the predetermined value (step S106). After selecting the encryption scheme, the encryption scheme determination unit 140 ends the attempt to change the encryption scheme.

While the encryption scheme is not selected and the encryption scheme that has not been examined remains in the evaluation targets, the encryption scheme determination unit 140 repeatedly executes the processing of steps S104 to S105. The processing of steps S104 to S105 is repeatedly executed for each encryption scheme.

When all the encryption schemes to be evaluated are examined, the encryption scheme determination unit 140 exits the selection loop (step S107). After exiting the selection loop, the encryption scheme determination unit 140 does not change the encryption scheme (step S108). The encryption scheme determination unit 140 ends the attempt to change the encryption scheme without changing the encryption scheme.

The evaluation function E_i of the i-th encryption scheme examined by the predetermined algorithm showed in FIG. 4 is expressed, for example, as follows.

E_i (the number of times of query execution, the error count, the number of times of execution under the first condition, the number of times of execution under the second condition, . . . , the number of times of execution under the m-th condition, relevance of the first condition, relevance of the second condition, . . . , relevance of the m-th condition)

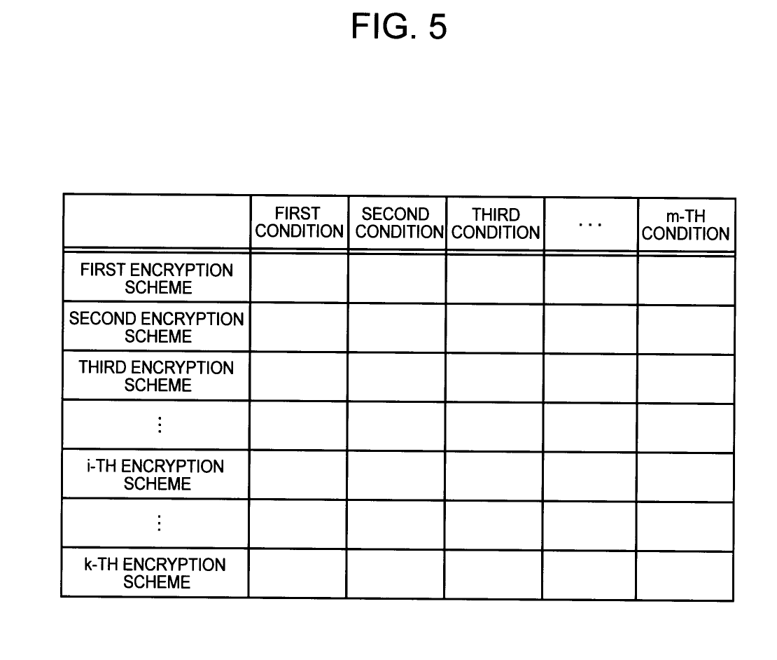

Note that, i is an integer of 1 or more and k or less, and k is an integer of 2 or more. For example, values of a relevance table are used as the relevance of the first condition, the relevance of the second condition, . . . , and the relevance of the m-th condition in the evaluation function E_i of the i-th encryption scheme. FIG. 5 is an explanatory diagram showing an example of the relevance table in which relevance between a condition and an encryption scheme is held.

As showed in FIG. 5, in the relevance table, each relevance are held between the first encryption scheme, the second encryption scheme, the third encryption scheme, . . . , the i-th encryption scheme, . . . , and the k-th encryption scheme and the respective conditions.

The relevance is represented by a numerical value between 0 and 1, for example. In a case where the relevance is represented by the numerical value between 0 and 1, it means that the larger the numerical value of the relevance is, the more the encryption scheme is suitable for the target condition.

As described above, an example of the predetermined algorithm included in the encryption scheme determination unit 140 has been described; however, the predetermined algorithm included in the encryption scheme determination unit 140 may be another algorithm.

As showed in FIG. 1, the center 200 includes the client synchronization unit 230 and an encryption scheme table (master). The client synchronization unit 230 communicates with encryption scheme determination units of the respective n clients. The client synchronization unit 230 refers to and updates the encryption scheme table (master).

The client synchronization unit 230 includes statistical data (master). The form of the statistical data (master) is similar to the form of the statistical data included in the encryption scheme determination unit 140.

In a case where the client includes the machine learning, the client synchronization unit 230 further includes a learning model (master). The form of the learning model (master) is similar to the form of the learning model included in the encryption scheme determination unit 140.

### DESCRIPTION OF OPERATION

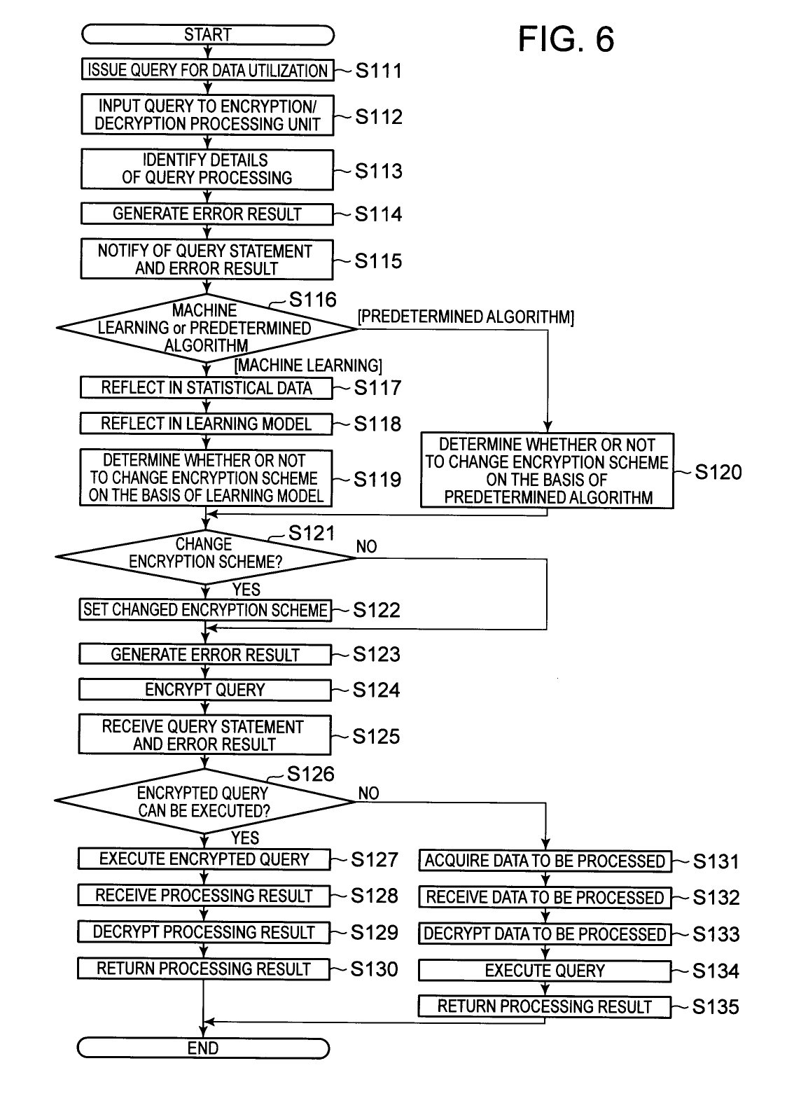

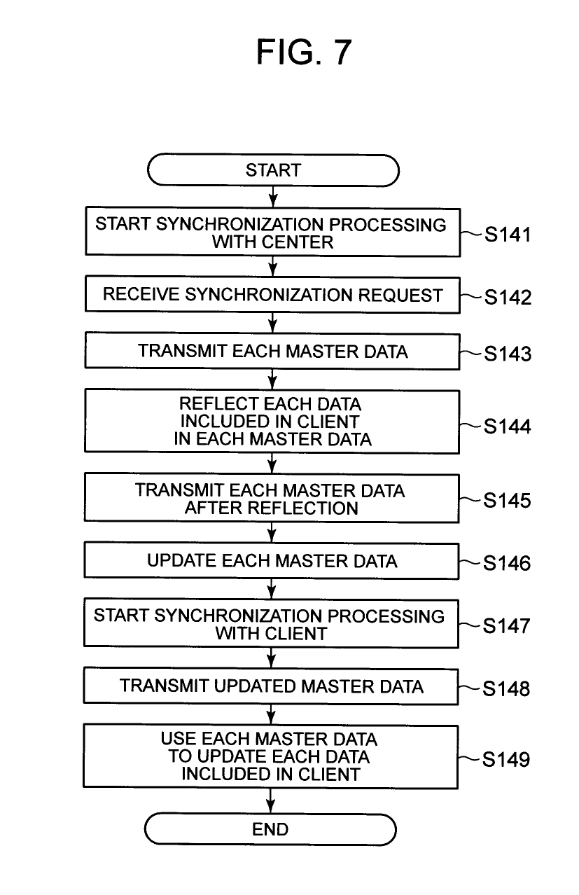

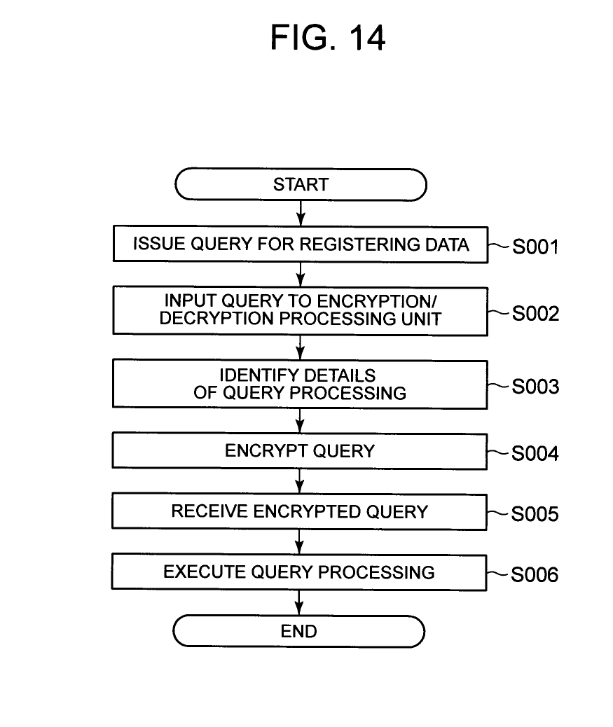

Hereinafter, operation will be described of the encrypted database system 10 showed in FIG. 1 with reference to FIGS. 6 to 7. Note, operation of “processing of registration and the like” by the encrypted database system 10 showed in FIG. 1 is similar to operation of data registration processing showed in FIG. 14.

First, operation will be described of performing “processing of data utilization” on the registered data of the encrypted database system 10 showed in FIG. 1 with reference to FIG. 6. FIG. 6 is a flowchart showing operation of data utilization processing by the encrypted database system 10 of the first exemplary embodiment.

A query for performing the “processing of data utilization” is issued from an external system 20 to the external interface unit 110 (step S111). The external interface unit 110 inputs the issued query to the encryption/decryption processing unit 130 (step S112).

Next, the encryption/decryption processing unit 130 identifies details of the query processing on the basis of the received query (step S113).

Next, the encryption/decryption processing unit 130 refers to the encryption scheme table to confirm the encryption scheme set for a column of a table to be subjected to the query processing. The encryption/decryption processing unit 130 generates an error result including information indicating whether or not the query encrypted with the confirmed encryption scheme can be executed (step S114).

Next, the encryption/decryption processing unit 130 inputs the query statement and error result including the query itself and the information of the generated error result to the encryption scheme determination unit 140. The encryption scheme determination unit 140 receives the query statement and error result (step S115).

In a case where the encryption scheme determination unit 140 includes the machine learning (“machine learning” in step S116), the encryption scheme determination unit 140 reflects the received query statement and error result, in the statistical data (step S117).

Next, the encryption scheme determination unit 140 executes the machine learning to reflect the statistical data after the query statement and error result are reflected, in the learning model (step S118).

For example, in a case where the error rate (=the error count/the number of times of query execution) in the statistical data exceeds a predetermined value or in a case where the number of times of query execution exceeds a predetermined value, the encryption scheme determination unit 140 excludes the statistical data of which the predetermined value is exceeded and updates the learning model.

After updating the learning model, the encryption scheme determination unit 140 determines whether or not to change the encryption scheme on the basis of the updated learning model (step S119).

In a case where the encryption scheme determination unit 140 includes the predetermined algorithm (“predetermined algorithm” in step S116), the encryption scheme determination unit 140 attempts to change the encryption scheme in accordance with the predetermined algorithm as in the operation showed in FIG. 4.

While attempting to change the encryption scheme, the encryption scheme determination unit 140 may refer to the received query statement and error result to confirm whether or not the error rate exceeds the predetermined value, or whether or not the number of times of query execution exceeds the predetermined value. The encryption scheme determination unit 140 attempts to change the encryption scheme to determine whether or not to change the encryption scheme (step S120).

In a case where the encryption scheme is changed (Yes in step S121), the encryption scheme determination unit 140 sets the changed encryption scheme in the encryption scheme table (step S122).

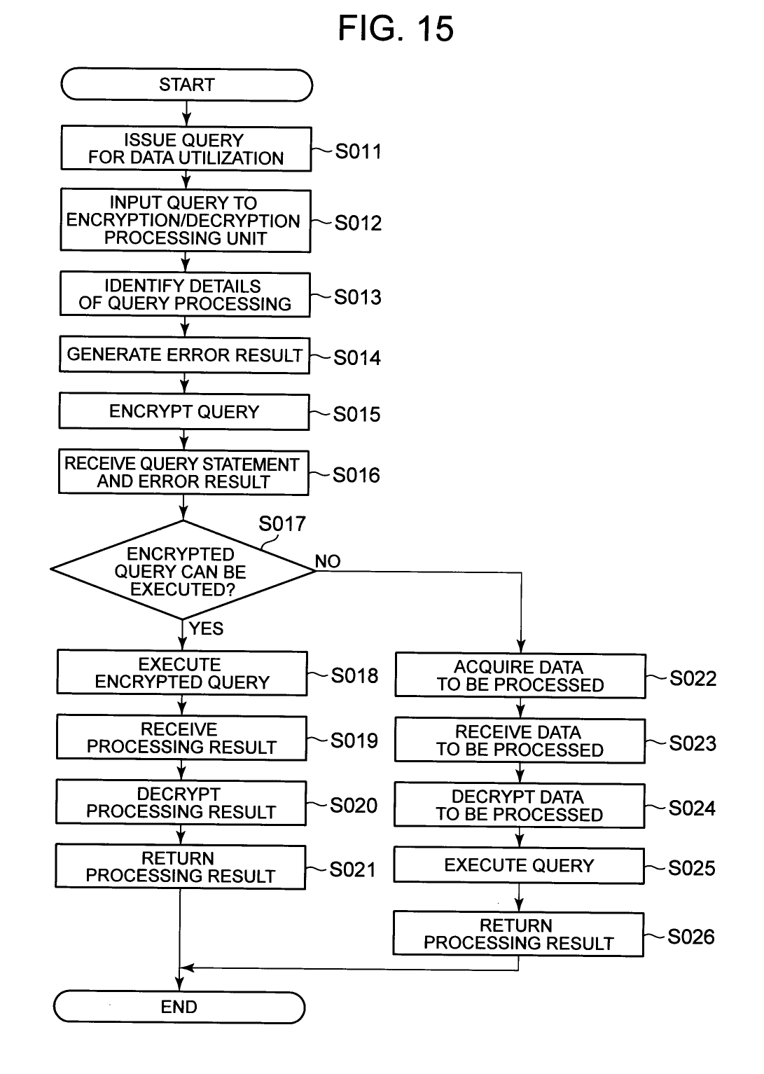

The processing of steps S123 to S135 is similar to the processing of steps S014 to S026 showed in FIG. 15.

Next, operation will be described of synchronization with the encryption scheme table, the statistical data, and the learning model included in the multiple clients of the encrypted database system 10 showed in FIG. 1 with reference to FIG. 7. FIG. 7 is a flowchart showing operation of data synchronization processing by the encrypted database system 10 of the first exemplary embodiment.

In this example, a case is assumed where the encryption scheme determination unit 140 includes the machine learning out of the predetermined algorithm and the machine learning. In this example, a case is assumed where the client 100 executes the data synchronization processing; however, the other clients also execute the data synchronization processing similarly to the processing showed in FIG. 7.

The client 100 starts synchronization processing with the center 200 in response to a predetermined trigger (step S141). The predetermined trigger is, for example, update of the encryption scheme table included in the client 100.

Next, the encryption scheme determination unit 140 issues a synchronization request to the client synchronization unit 230 of the center 200. The client synchronization unit 230 receives the synchronization request (step S142).

Next, the client synchronization unit 230 transmits the encryption scheme table (master), the statistical data (master), and the learning model (master) to the requesting client 100 (step S143).

Next, the client 100 reflects the encryption scheme table, statistical data, and learning model included in the client 100 for the data of the received encryption scheme table (master), statistical data (master), and learning model (master) (step S144).

For example, in a case of the encryption scheme table, the client 100 sets the encryption scheme set in the encryption scheme table for the received encryption scheme table (master).

In a case of the statistical data, the client 100 adds values of the statistical data to the received statistical data (master) to update the statistical data (master).

In a case of the learning model, the client 100 adds plot data as a generation source of the learning model to the received learning model (master) to update the learning model (master).

Next, the client 100 transmits the data of the encryption scheme table (master), statistical data (master), and learning model (master) after the data of the client 100 is reflected, to the client synchronization unit 230 of the center 200 (step S145).

To secure security, the client 100 may encrypt the data of the statistical data (master) and learning model (master) in advance before transmission and then transmit each encrypted data to the center 200. The center 200 can always hold master data in the encrypted state.

Next, the client synchronization unit 230 uses the data of the received encryption scheme table (master), statistical data (master), and learning model (master) to update each of the encryption scheme table (master), statistical data (master), and learning model (master) included in the client synchronization unit 230 (step S146).

The center 200 starts synchronization processing with one or more clients other than the client 100 in response to a predetermined trigger (step S147). In this example, the center 200 starts the synchronization processing with the client 101. The predetermined trigger is, for example, update of any of the encryption scheme table (master), the statistical data (master), and the learning model (master).

After starting the synchronization processing with the client, the center 200 transmits the updated data of the encryption scheme table (master), the statistical data (master), and the learning model (master), to the encryption scheme determination unit 140 of the client 101 (step S148).

Next, the encryption scheme determination unit 140 of the client 101 uses the received data of the encryption scheme table (master), the statistical data (master), and the learning model (master) to update the encryption scheme table, statistical data, or learning model included in the client 101 (step S149).

The encryption scheme determination unit 140 updates each data similarly to the processing of step S144, for example. After updating each data, the encrypted database system 10 ends the data synchronization processing.

Through the above processing, the client synchronization unit 230 of the center 200 can synchronize each data of the encryption scheme table, statistical data, and learning model updated by the client 100 with each data of those of other clients.

In a case where the encryption scheme determination unit 140 includes the predetermined algorithm out of the predetermined algorithm and the machine learning, the operation on the learning model is excluded out of the operation of the data synchronization processing described above. The data synchronization processing showed in FIG. 7 may be executed in parallel with the data utilization processing showed in FIG. 6. The predetermined algorithm may be a target of the data synchronization processing.

For synchronization with the statistical data (master) and learning model (master) included in the center 200, the encryption scheme determination unit 140 of the client 100 may hold a history of the query statement. The encryption scheme determination unit 140 may use the history of the query statement to update each of the statistical data (master) and learning model (master) included in the center 200.

The history of the query statement is information including at least the query statement itself of the executed query and information indicating execution order of a sequential ID, time stamp, and the like of the executed query. The history of the query statement is, for example, an execution log of Structured Query Language (SQL).

The history of the query statement is used for updating learning data that is difficult to be updated by simply summing up the data included in the clients and the data included in the center such as the statistical data and the learning model described above. Specifically, it is possible to reflect two pieces of the learning data by learning another learning data and the history of the query statement.

For example, like the learning data in deep learning, for learning data A generated by the machine learning and learning data B generated by the other machine learning, it is usually difficult to generate the learning data reflecting two pieces of data, the learning data A and the learning data B. However, when the machine learning similar to the machine learning performed on the learning data A is performed on the learning data B, the learning data reflected both pieces of data is generated.

In the data synchronization processing described above, the center 200 transmits the statistical data (master), the learning model (master), and the encryption scheme table (master) to the client; however, the client may transmit the statistical data, the learning model, and the encryption scheme table to the center 200. The center 200 updates each of the transmitted statistical data, learning model, and encryption scheme table.

### DESCRIPTION OF EFFECT

In a case where the “data class” is the “statistical data”, the encryption scheme determination unit 140 includes the statistical data. In a case where the query is issued, the encryption/decryption processing unit 130 inputs the query statement, and the query statement and error result indicating whether or not the error occurs when the query encrypted with the encryption scheme set in the encryption scheme table is executed, to the encryption scheme determination unit 140.

The encryption scheme determination unit 140 updates the statistical data on the basis of the input query statement and error result. The encryption scheme determination unit 140 uses the updated statistical data to select a more appropriate encryption scheme for each specific data area in accordance with the learning model generated by the machine learning or the predetermined algorithm. The selected encryption scheme is set in the encryption scheme table.

The encryption/decryption processing unit 130 uses the encryption scheme set in the encryption scheme table to perform data encryption processing. That is, the encryption scheme determination unit 140 selects the more appropriate encryption scheme, whereby a possibility is reduced that the query is not executed by the query execution unit 210 of the center 200. The ratio increases at which the query is executed by the query execution unit 210 of the center 200 whose processing performance is higher than that of the client, so that the total execution time of the query processing is shortened.

In the case where the “data class” is the “statistical data”, the client synchronization unit 230 of the center 200 includes the statistical data (master). Similarly to the case of the encryption scheme table, the encryption scheme determination unit 140 of the client updates the statistical data (master) via the client synchronization unit 230 of the center 200 in response to the predetermined trigger.

The client synchronization unit 230 of the center 200 updates each piece of the statistical data via each encryption scheme determination unit of the corresponding other client on the basis of the statistical data (master) in response to the predetermined trigger. With the synchronization processing described above, the set data of the appropriate encryption scheme is delivered to each client, whereby the execution time of the query processing is shortened not only in one client but also in the entire encrypted database system 10.

### SECOND EXEMPLARY EMBODIMENT

### Description of Configuration

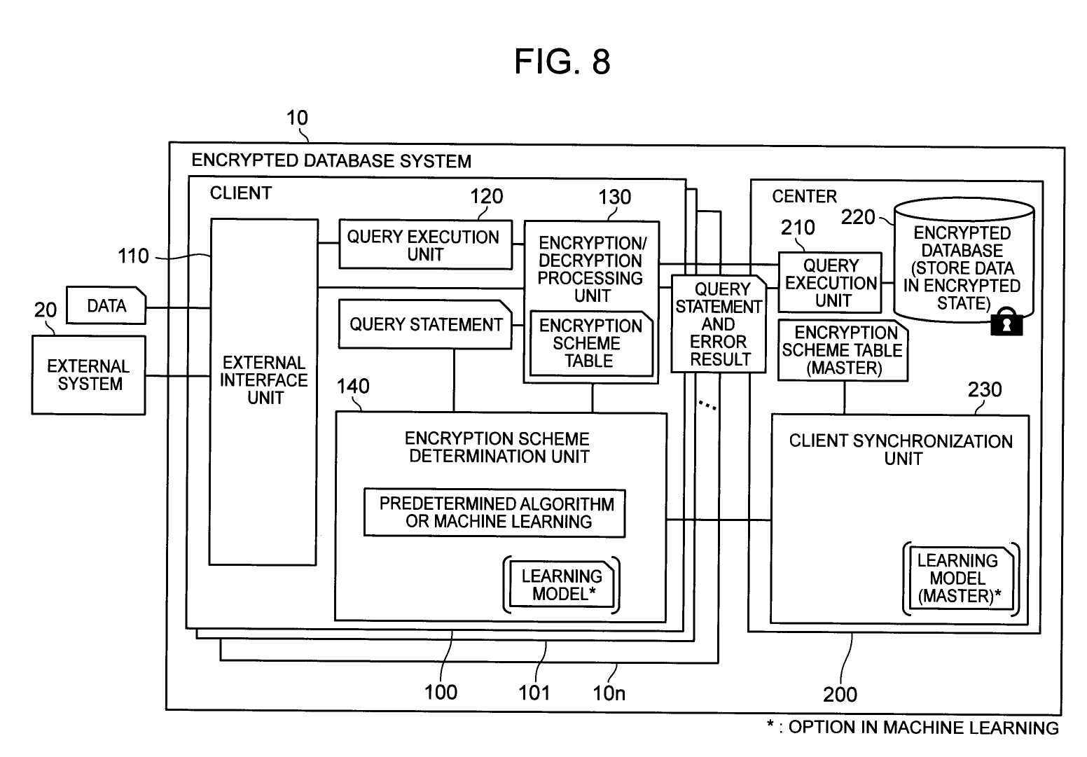

Next, a second exemplary embodiment of the present invention will be described with reference to the drawings. FIG. 8 is a block diagram showing a configuration example of the second exemplary embodiment of the encrypted database system 10 according to the present invention. As described above, the “data class” of the present exemplary embodiment includes the “data” and the “metadata”.

The configuration of the encrypted database system 10 of the present exemplary embodiment is similar to the configuration of the encrypted database system 10 of the first exemplary embodiment except that an encryption scheme determination unit 140 does not include the statistical data and that a client synchronization unit 230 does not include the statistical data (master).

An encryption/decryption processing unit 130 of the present exemplary embodiment has a function of inputting a query statement indicated by an input query to the encryption scheme determination unit 140. Unlike the query statement and error result of the first exemplary embodiment, the query statement need not include information indicating an error result.

In a case where the encryption scheme determination unit 140 includes machine learning out of a predetermined algorithm and the machine learning, the encryption scheme determination unit 140 includes a learning model. The encryption scheme determination unit 140 generates and updates the learning model on the basis of the data class (the data and the meta data) described in the query statement input to the encryption scheme determination unit 140 and an encryption scheme set in an encryption scheme table.

The learning model of the present exemplary embodiment is a model in which a correspondence between the data class and the encryption scheme is learned. For example, in a case where many of the data are any of “male”, “female”, or Null, and the metadata (for example, a label name) is a “gender”, there is a high possibility that an appropriate encryption scheme for the data class is a “searchable probabilistic encryption scheme”.

In a case where many of the data are either a number or null, and the metadata (for example, a label name) is a “score”, there is a high possibility that the appropriate encryption scheme for the data class is a “homomorphic encryption scheme”.

Various methods are known as a method for mechanically learning a correspondence between the data and a set value (the encryption scheme of the present exemplary embodiment) already set on the basis of a large number of data class.

In a case where the encryption scheme determination unit 140 includes the predetermined algorithm out of the predetermined algorithm and the machine learning, the encryption scheme determination unit 140 selects the appropriate encryption scheme in accordance with the predetermined algorithm set in advance.

Specifically, the encryption scheme determination unit 140 sets the appropriate encryption scheme selected in accordance with the predetermined algorithm on the basis of the data class (the data and the metadata) described in the query statement input to the encryption scheme determination unit 140, in the encryption scheme table included in the encryption/decryption processing unit 130.

The predetermined algorithm is an algorithm set in advance on the basis of an empirical rule as described in PTL 2, for example.

### DESCRIPTION OF OPERATION

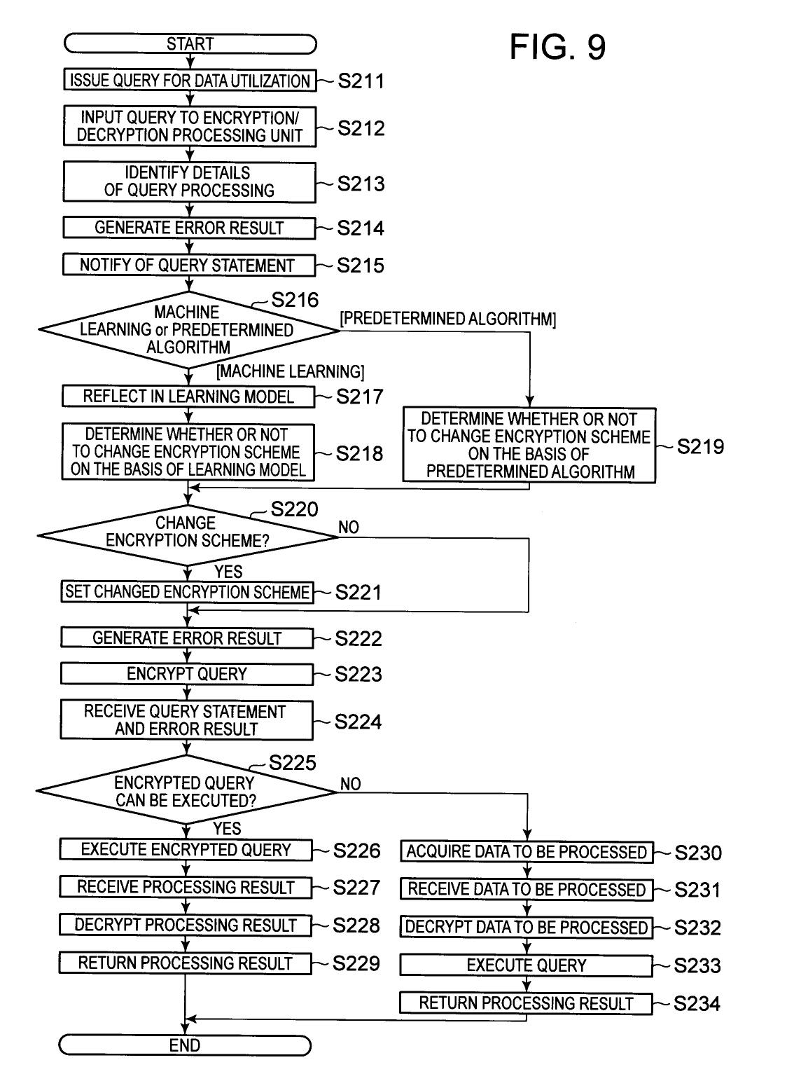

Hereinafter, operation will be described of the encrypted database system 10 showed in FIG. 8 with reference to FIG. 9. Note, operation of “processing of registration and the like” by the encrypted database system 10 showed in FIG. 8 is similar to the operation of the data registration processing showed in FIG. 14.

First, operation will be described of performing “processing of data utilization” on the registered data of the encrypted database system 10 showed in FIG. 8 with reference to FIG. 9. FIG. 9 is a flowchart showing the operation of the data utilization processing by the encrypted database system 10 of the second exemplary embodiment.

A query for performing the “processing of data utilization” is issued from an external system 20 to an external interface unit 110 (step S211). The external interface unit 110 inputs the issued query to the encryption/decryption processing unit 130 (step S212).

Next, the encryption/decryption processing unit 130 identifies details of query processing on the basis of the received query (step S213).

Next, the encryption/decryption processing unit 130 refers to the encryption scheme table to confirm the encryption scheme set for a column of a table to be subjected to the query processing. The encryption/decryption processing unit 130 generates an error result including information indicating whether or not the query encrypted with the confirmed encryption scheme can be executed (step S214).

Next, the encryption/decryption processing unit 130 inputs the query statement indicated by the input query to the encryption scheme determination unit 140. The query statement includes information of the query itself. The encryption scheme determination unit 140 receives the input query statement (step S215).

In a case where the encryption scheme determination unit 140 includes the machine learning (the “machine learning” in step S216), the encryption scheme determination unit 140 executes the machine learning to reflect the received query statement in the learning model (step S217).

Next, the encryption scheme determination unit 140 determines an appropriate encryption scheme on the basis of the learning model after the query statement is reflected (step S218). That is, the encryption scheme determination unit 140 determines whether or not to change the encryption scheme.

In a case where the encryption scheme determination unit 140 includes the predetermined algorithm (the “predetermined algorithm” in step S216), the encryption scheme determination unit 140 determines an appropriate encryption scheme on the basis of the received query statement in accordance with the predetermined algorithm (step S219). That is, the encryption scheme determination unit 140 determines whether or not to change the encryption scheme.

In a case where the encryption scheme is changed (Yes in step S220), the encryption scheme determination unit 140 sets the changed encryption scheme in the encryption scheme table (step S221).

The processing of steps S222 to S234 is similar to the processing of steps S014 to S026 showed in FIG. 15.

The encrypted database system 10 of the present exemplary embodiment can also execute the data synchronization processing showed in FIG. 7 similarly to the encrypted database system 10 of the first exemplary embodiment. That is, the encryption scheme determination unit 140 of the client updates an encryption scheme table (master) via the client synchronization unit 230 of a center 200 in response to a predetermined trigger. The predetermined trigger is, for example, update of the encryption scheme table included in the client.

The client synchronization unit 230 of the center 200 updates each of the encryption scheme tables via each encryption scheme determination unit of the corresponding other client on the basis of the encryption scheme table (master) in response to a predetermined trigger. The predetermined trigger is, for example, update of the encryption scheme table (master) included in the center 200. The synchronization processing described above is executed, whereby execution time of the query processing is shortened not only in one client but also in the entire encrypted database system 10.

### DESCRIPTION OF EFFECT

In a case where the “data class” includes the “data” and the “metadata”, the encryption scheme determination unit 140 selects a more appropriate encryption scheme for each specific data area in accordance with the learning model generated by the machine learning or the predetermined algorithm on the basis of the input “data class”. The selected encryption scheme is set in the encryption scheme table.

The encryption/decryption processing unit 130 uses the encryption scheme set in the encryption scheme table to perform data encryption processing. That is, in a case where the encryption scheme determination unit 140 selects the more appropriate encryption scheme, the ratio increases at which the query is executed in the encrypted state, so that a total of the execution time of the query processing is shortened.

Although only one center is included in the encrypted database system 10 of each exemplary embodiment, two or more centers may be included in the encrypted database system 10. In a case where two or more centers are included, for example, one center may operate similarly to the center 200 in each exemplary embodiment, and the other center may be used for the purpose of backup, or the purpose of disaster recovery in which recovery is performed when a disaster occurs.

The data may be distributed and stored in two or more centers. The centers may store the data while synchronizing with each other. In a case where the centers store the data while synchronizing with each other, each query execution unit of the two or more centers notifies other centers of information indicating completion of the “processing of registration and the like” to the encrypted database. Also in the other centers, in a case where the “processing of registration and the like” is completed, each query execution unit is notified of the information indicating the completion.

In a case where the centers store the data while synchronizing with each other, for example, each column of the table stored in the encrypted database may include a valid bit. In a case where the valid bit exists, after the “processing of registration and the like” is completed at each center, the valid bit is changed from a value indicating invalid to a value indicating valid. That is, the column in which the valid bit indicates validity is the column in a synchronized state.

In each exemplary embodiment, the encryption scheme determined after the encryption scheme is determined is set in the encryption scheme table, and after the setting, the query is encrypted and the query processing is executed. However, determination of the encryption scheme and execution of the encrypted query may be performed in parallel. In a case where the two processes are performed in parallel, the changed encryption scheme is used, in execution of the next and subsequent query processing, for the column of the table to be subjected to the query processing.

In a case where the query processing cannot be executed by the center, the center of each exemplary embodiment acquires all the data to be subjected to the query processing, and transmits the data in the encrypted state to the encryption/decryption processing unit of the client requesting the processing. The data transmitted may include data other than the data to be subjected to the query processing.

For example, in a case where the sum of the values of other columns is obtained for the data that can be subjected to the match search by the center as described above, all the corresponding data (values) of other columns are transmitted. However, all the data of the column subjected to the match search and all the data of other columns may be transmitted. In a case where all the data are transmitted, an amount of data transfer increases.

In each exemplary embodiment, a unit of the specific data area is a column of the table; however, the unit of the specific data area may be a row of the table, or another area in the table. The unit of the specific data area may be designated by utilizing a table indicating a combination of a unique number and an exclusive area.

In each exemplary embodiment, the encryption scheme set for the column of the table is one encryption scheme except for a difference occurring in a period from update to synchronization. However, different encryption schemes may be set for respective clients, for one column of the table. In a case where the different encryption schemes are set for the respective clients, for example, two or more columns of the encryption scheme table are used for the one column of the table.

The clients 100 to 10n and the center 200 of each exemplary embodiment are realized by, for example, a Central Processing Unit (CPU) that executes processing in accordance with a program stored in a non-transitory storage medium such as Read Only Memory (ROM) or a hard disk. That is, the external interface unit 110, the query execution unit 120, the encryption/decryption processing unit 130, the encryption scheme determination unit 140, the query execution unit 210, and the client synchronization unit 230 are realized by, for example, the CPU that executes processing in accordance with program control.

The encrypted database 220 is realized by, for example, Random Access Memory (RAM).

Units in the clients 100 to 10n and units in the center 200 of each exemplary embodiment may be realized by hardware circuits. As an example, the external interface unit 110, the query execution unit 120, the encryption/decryption processing unit 130, the encryption scheme determination unit 140, the query execution unit 210, the encrypted database 220, and the client synchronization unit 230 are each realized by a Large Scale Integration (LSI). Also, those LSIs may be realized by one LSI.

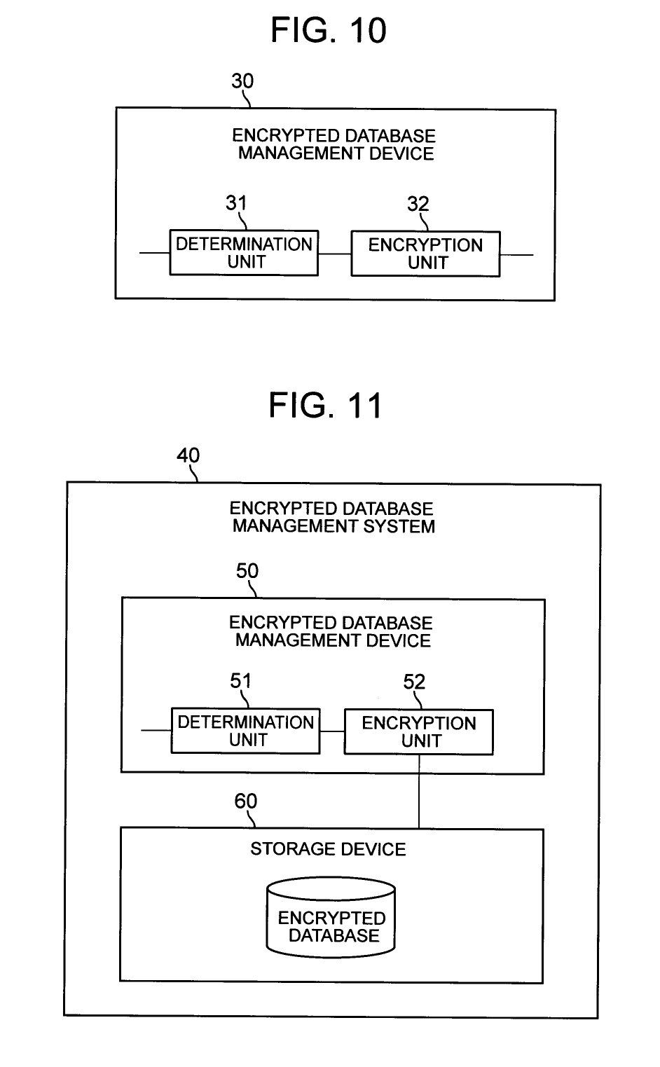

Next, an outline of the present invention will be described. FIG. 10 is a block diagram showing an outline of an encrypted database management device according to the present invention. An encrypted database management device 30 according to the present invention includes: a determination unit 31 (for example, the encryption scheme determination unit 140) which determines an encryption scheme used for encrypting a query, on the basis of the query and a predetermined model; and an encryption unit 32 (for example, the encryption/decryption processing unit 130) which uses the encryption scheme determined to encrypt the query.

With such a configuration, the encrypted database management device can encrypt the query issued to an encrypted database with an appropriate encryption scheme.

The predetermined model may be a learning model generated by execution of machine learning.

With such a configuration, the encrypted database management device can use the learning model to determine the appropriate encryption scheme.

The determination unit 31 may include statistical data that is data in which a result of execution of an encrypted query is accumulated, and execute machine learning using the statistical data to generate the learning model.

The statistical data may include details of query processing on the encrypted database and an execution error result of the query processing. The statistical data may include information of data stored in the encrypted database and information of the metadata of the data.

With such a configuration, the encrypted database management device can use the learning model reflected the execution result of past query processing to determine the appropriate encryption scheme.

The determination unit 31 may execute the machine learning using the information of the data stored in the encrypted database and the information of the metadata of the data to generate the learning model.

The predetermined model may be a model generated on the basis of a predetermined algorithm.

The predetermined algorithm may be an algorithm generated on the basis of the details of the query processing on the encrypted database. The predetermined algorithm may be an algorithm generated on the basis of the data stored in the encrypted database and the metadata of the data.

With such a configuration, the encrypted database management device can use a fixed algorithm set in advance to determine the appropriate encryption scheme.

FIG. 11 is a block diagram showing an outline of an encrypted database management system according to the present invention. An encrypted database management system 40 according to the present invention includes an encrypted database management device 50 and a storage device 60 including an encrypted database (for example, the encrypted database 220) storing encrypted data, in which the encrypted database management device 50 includes: a determination unit 51 (for example, the encryption scheme determination unit 140) which determines an encryption scheme used for encrypting a query, on the basis of the query and a predetermined model; and an encryption unit 52 (for example, the encryption/decryption processing unit 130) which uses the encryption scheme determined to encrypt the query.

With such a configuration, the encrypted database management system can encrypt the query issued to an encrypted database with an appropriate encryption scheme.

The storage device 60 does not decrypt the encrypted query when the query processing on the encrypted database is executed.

The predetermined model may be a learning model generated by execution of machine learning.

With such a configuration, the encrypted database management system can use the learning model to determine the appropriate encryption scheme.

The encrypted database management system 40 may include a plurality of the encrypted database management devices, and the storage device 60 may include a synchronization unit (for example, the client synchronization unit 230), the determination unit 51 of the encrypted database management device 50 may notify the synchronization unit of the encryption scheme determined, and the synchronization unit may notify the encrypted database management devices other than the encrypted database management device 50 of the encryption scheme notified.

With such a configuration, the encrypted database management system can reduce the execution time of the query processing over the entire system.

The determination unit 51 of the encrypted database management device 50 may notify the synchronization unit of the predetermined model used for determination, and the synchronization unit may notify the encrypted database management devices other than the encrypted database management device 50 of the predetermined model notified.

With such a configuration, the encrypted database management system can unify the encryption scheme used for encryption over the entire system.

An encryption scheme is manually set for a large number of data areas by a user who does not have expert knowledge or skill in a general encrypted database system. Therefore, data is often encrypted with an inappropriate encryption scheme.

In a case where the data is encrypted with the inappropriate encryption scheme as described above, there are cases where the encryption scheme is not suitable for the purpose of use of the data and the like. For example, in a case where a search with a few patterns such as a gender is not performed, and sequence comparison and an arithmetic operation are not performed either, a first case, in which a “searchable probabilistic encryption scheme” is set even though a “deterministic encryption scheme” is appropriate as the encryption scheme, corresponds to the case described above. The “searchable probabilistic encryption scheme” is an encryption scheme appropriate in a case where a search is performed with a few patterns such as the gender as described above.

In a case where magnitude comparison is performed, a second case, in which a “homomorphic encryption scheme” is set even though a “sequence comparison encryption scheme” is appropriate as the encryption scheme, corresponds to the case described above. The “homomorphic encryption scheme” is an encryption scheme appropriate in a case where an arithmetic operation is performed as described above.

Even in a case where the query is encrypted with the inappropriate encryption scheme, the query processing is executed on the query in the encrypted state. However, in the first case, for example, there is a problem that it takes more time to execute the query processing. In the second case, since the client executes the query processing after the encrypted query is once decrypted, there is a problem that it takes more time for the entire processing.

That is, the first case corresponds to a case where the inappropriate encryption scheme is set in the encryption scheme table, regardless of whether or not the query processing can be executed by the center 200. In the first case, the query execution unit 120 of the client 100 or the query execution unit 210 of the center 200 requires more time for execution of the query processing than in a case where the registered data and the query are encrypted with the appropriate encryption scheme.

The second case corresponds to a case where the query processing cannot be executed by the center 200. In the second case, the center 200 transmits all the data to be subjected to the query processing stored in the encrypted database 220 to the client requesting the execution of the query processing. Since processing performance of many clients is inferior to processing performance of the center 200, each client requires more time than the center 200 to execute the query processing.

According to the present invention, a query issued to an encrypted database can be encrypted with an appropriate encryption scheme.

While the invention has been particularly shown and described with reference to exemplary embodiments thereof, the invention is not limited to these embodiment. It will be understood by those of ordinary skill in the art that various changes in form and details may be made therein without departing from the spirit and scope of the present invention as defined by the claims.

What is claimed is:

1. An encrypted database system comprising:
a determination unit which determines an encryption scheme used for encrypting a query, on the basis of the query and a predetermined model; and
an encryption unit which uses the encryption scheme determined to encrypt the query.

2. The encrypted database system according to claim 1, wherein
the predetermined model is a learning model generated by execution of machine learning.

3. The encrypted database system according to claim 2, wherein
the determination unit
includes statistical data that is data in which a result of execution of an encrypted query is accumulated, and
executes machine learning using the statistical data to generate the learning model.

4. The encrypted database system according to claim 1, wherein
the predetermined model is a model generated on the basis of a predetermined algorithm.

5. The encrypted database system according to claim 1, further comprising
a plurality of the encrypted database management devices; and
a storage device including an encrypted database storing encrypted data, wherein
the storage device includes a synchronization unit,
a determination unit of a predetermined one of the encrypted database management devices notifies the synchronization unit of the encryption scheme determined, and
the synchronization unit notifies the encrypted database management devices other than the predetermined one of the encrypted database management devices of the encryption scheme notified.

6. The encrypted database system according to claim 2, further comprising
a plurality of the encrypted database management devices; and
a storage device including an encrypted database storing encrypted data, wherein
the storage device includes a synchronization unit,
a determination unit of a predetermined one of the encrypted database management devices notifies the synchronization unit of the encryption scheme determined, and
the synchronization unit notifies the encrypted database management devices other than the predetermined one of the encrypted database management devices of the encryption scheme notified.

7. The encrypted database system according to claim 3, further comprising
a plurality of the encrypted database management devices; and
a storage device including an encrypted database storing encrypted data, wherein
the storage device includes a synchronization unit,
a determination unit of a predetermined one of the encrypted database management devices notifies the synchronization unit of the encryption scheme determined, and
the synchronization unit notifies the encrypted database management devices other than the predetermined one of the encrypted database management devices of the encryption scheme notified.

8. The encrypted database system according to claim 4, further comprising
a plurality of the encrypted database management devices; and
a storage device including an encrypted database storing encrypted data, wherein
the storage device includes a synchronization unit,
a determination unit of a predetermined one of the encrypted database management devices notifies the synchronization unit of the encryption scheme determined, and
the synchronization unit notifies the encrypted database management devices other than the predetermined one of the encrypted database management devices of the encryption scheme notified.

9. The encrypted database system according to claim 5, wherein
the determination unit of the predetermined one of the encrypted database management devices notifies the synchronization unit of the predetermined model used for determination, and
the synchronization unit notifies the encrypted database management devices other than the predetermined one of the encrypted database management devices of the predetermined model notified.

10. The encrypted database system according to claim 6, wherein
the determination unit of the predetermined one of the encrypted database management devices notifies the synchronization unit of the predetermined model used for determination, and
the synchronization unit notifies the encrypted database management devices other than the predetermined one of the encrypted database management devices of the predetermined model notified.

11. The encrypted database system according to claim 7, wherein
the determination unit of the predetermined one of the encrypted database management devices notifies the synchronization unit of the predetermined model used for determination, and
the synchronization unit notifies the encrypted database management devices other than the predetermined one of the encrypted database management devices of the predetermined model notified.

12. The encrypted database system according to claim 8, wherein
the determination unit of the predetermined one of the encrypted database management devices notifies the synchronization unit of the predetermined model used for determination, and
the synchronization unit notifies the encrypted database management devices other than the predetermined one of the encrypted database management devices of the predetermined model notified.

13. An encrypted database management method comprising:
determining an encryption scheme used for encrypting a query, on the basis of the query and a predetermined model; and
using the encryption scheme determined to encrypt the query.

14. A non-transitory computer-readable recording medium having recorded therein an encrypted database management program that, when executed by a computer,
determines an encryption scheme used for encrypting a query, on the basis of the query and a predetermined model, and
uses the encryption scheme determined to encrypt the query.
